(19) United States
(12) Patent Application Publication
(10) Pub. No.: US 2002/0071402 A1
(43) Pub. Date: Jun. 13, 2002

(54) Bit error rate in a TDMA frequency hopping spread spectrum system by using additional transmit slots

(75) Inventors: Juergen Kockmann, Duesseldorf (DE); Uwe Sydon, Duesseldorf (DE); Olaf Dicker, Rees (DE)

Correspondence Address: Siemens Corporation, Intellectual Property Department, 186 Wood Avenue South, Iselin, NJ, 08830, US

(73) Assignee: SIEMENS INFORMATION AND COMMUNICATION PRODUCTS, LLC.

(21) Appl. No.: 09/728,879

(22) Filed: Dec. 1, 2000

(51) Int. Cl. H04B 7/212

(52) U.S. Cl. 370/330; 370/337; 375/132

(57) ABSTRACT

A frequency hopping cordless telephone system is provided, including a base station and one or more mobile units. The base station and mobile units are adapted to determine if a carrier frequency has been interfered with. If so, and if a next frame has slots available, the lost slot(s) are resent, along with those next in queue. A ring buffer memory is provided to receive both the resent slot(s) and the current one. The slots are read into the memory at a first rate and read out at a higher rate.

### BACKGROUND OF THE INVENTION

1. Field of the Invention

The present invention relates to telecommunication systems and, particularly, to a system that is more robust against in-band interferers.

2. Description of the Related Art

The Digital Enhanced Cordless Telecommunications (DECT) standard, promulgated by the European Telecommunications Standards Institute (ETSI), is an accepted standard for cordless telephones. DECT is based on a micro-cellular radio communication system using Time Division Multiple Access and Time Division Duplexing.

The Worldwide Digital Cordless Telecommunications (WDCT) system has been developed by Siemens Wireless Terminals as an FCC-compliant modification of DECT. WDCT is a frequency hopping spread spectrum system employing adaptive differential pulse code modulation (ADPCM).

The bit error rate (BER) and voice quality in a frequency hopping spread spectrum system depends largely on the number of interfered carriers. When a TDMA frame structure is used and a carrier is interfered with by a strong interferer, the probability that bit errors will occur, or a whole slot will be lost, is very high.

According to FCC part 15, a system must use in a random order at least n carriers. For a 2.4 GHz system, n=75. The number z of available carriers depends on system design. In addition, FCC part 15 requires that each carrier must not be used longer than x milliseconds every y seconds. For a 2.4 GHz system, x=400 ms, and y=30 seconds.

WDCT is based on a TDMA frame structure with a frame length of 10 milliseconds. Because of the TDMA structure, the frame is divided in receive and transmit slots. An exemplary WDCT frame for a mobile unit is shown in FIG. 1. Shown are a plurality of receive slots RX1-RX4 followed by a plurality of transmit slots TX1-TX4 (In the base station(s), the order of receive and transmit slots is reversed). Each active transmit or receive slot has a duration of 833 microseconds. If there are fewer than four connections, i.e., fewer than four pairs of slots are active, no data is transmitted during the inactive slots. Further, between two active slots an inactive slot of duration 417 microseconds is implemented.

According to a typical implementation of WDCT, one TX frame and one RX frame of the TDMA frame are used for an active connection. The same frequency is used for both slots. The frequency is changed with the beginning of a new frame. Each WDCT frame allows up to four active connections.

If a slot is interfered with, received data are not used. New data are resent in the next frame on a different frequency, but voice quality degradation will result, since data of one slot are missing.

### SUMMARY OF THE INVENTION

These and other drawbacks in the prior art are overcome in large part by a system and method according to the present invention. A frequency hopping cordless telephone system is provided, including a base station and one or more mobile units. The base station and mobile units are adapted to determine if a carrier frequency has been interfered with. If so, and if a next frame has slots available, the lost slot(s) are resent, along with those next in queue. Ring buffer memories are provided to synchronize the RF interface and the fixed network, and the RF interface and the user input/output.

### BRIEF DESCRIPTION OF THE DRAWINGS

A better understanding of the invention is obtained when the following detailed description is considered in conjunction with the following drawings in which:

FIG. I is a diagram of a data frame;

FIG. 2 is a block diagram of a system in accordance with an implementation of the invention;

FIG. 3 is a diagram illustrating frames according to an implementation of the invention;

FIG. 4 is a block diagram of a system according to an implementation of the present invention;

FIG. 5 is a diagram illustrating operation of a ring buffer according to an implementation of the invention; and

FIG. 6 is a flowchart illustrating operation of an implementation of the invention.

### DETAILED DESCRIPTION OF THE INVENTION

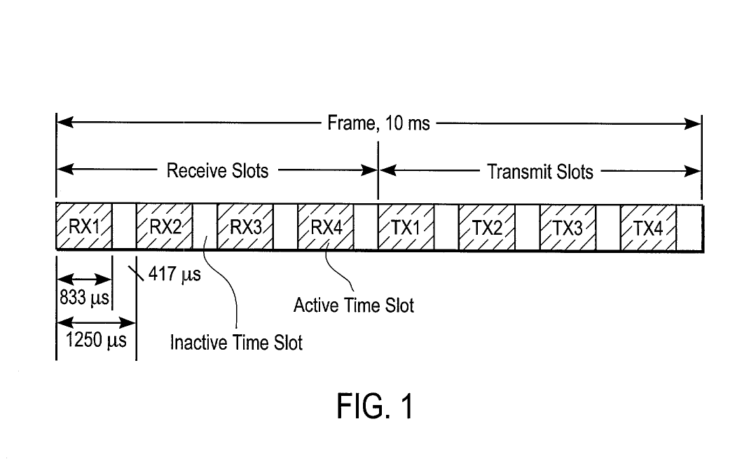

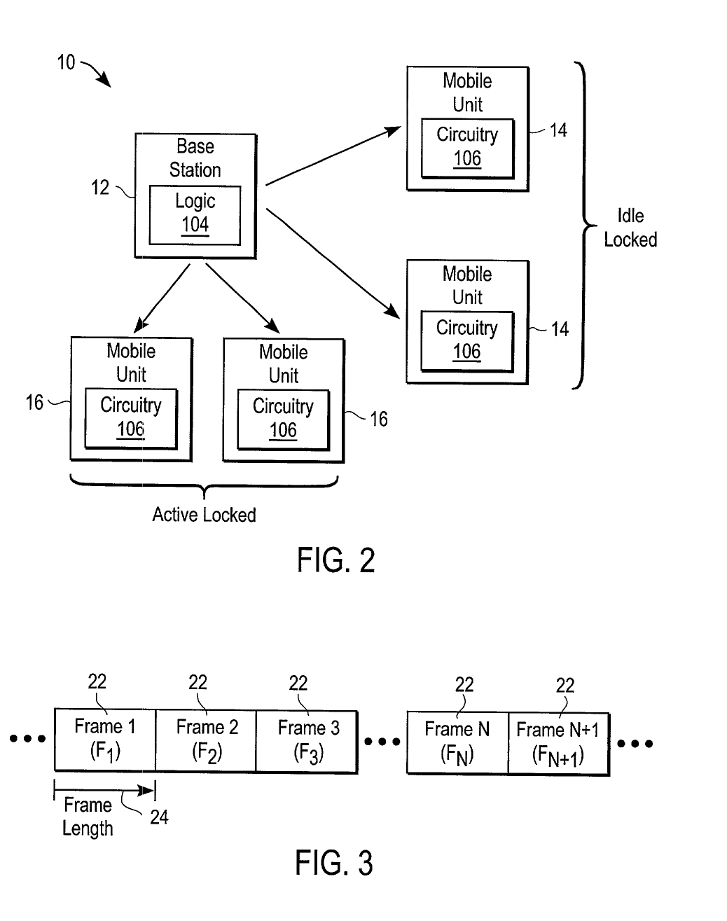

FIGS. 2-6 illustrate a telecommunications system including telecommunications devices according to an implementation of the present invention. A frequency hopping cordless telephone system is provided, including a base station and one or more mobile units. The base station and mobile units are adapted to determine if a carrier frequency has been interfered with. If so, and if a next frame has slots available, the lost slot(s) are resent, along with those next in queue. Ring buffer memories are provided to synchronize the RF interface and the fixed network, and the RF interface and the user input/output.

FIG. 2 is a block diagram of one implementation of an exemplary radio-frequency system according to the present invention. In particular, the system may be implemented as a frequency hopping cordless telephone system, indicated generally as 10. The system 10 includes one or more base stations 12, each of which can also be referred to as a fixed part (FP). Each base station 12 can support communication with a plurality of mobile units or handsets 14 and handsets 16 using radio frequencies. The interface between base station 12 and handsets 14 and 16 can be referred to as the air interface. The base station 12 includes control logic 104 and the handsets 14 and 16 include control logic 106 which function as transmitters and receivers, as well as implementing carrier quality functionality according to the present invention, as will be explained in greater detail below. An exemplary system suitable for use with a system according to the present invention is the Gigaset system, available from Siemens Corp.

In operation, base station 12 can support a defined total number of handsets 14 and 16. For example, in one implementation, base station 12 can support a total of eight handsets, either idle locked or active locked. Of the total number of handsets, a given number “M” can be active locked handsets 16. For example, base station 12 could support up to four active locked handsets 16 from the eight total handsets. Of the remaining handsets, base station 12 can support a given number “N” of idle locked handsets 14. For example, “N” can be less than or equal to the difference between the total number of supported handsets (e.g., 8) and the number “M” of active locked handsets 16 (e.g., 0-4). Idle locked handsets 14 are handsets that are currently inactive but are in contact with and in sync with base station 12. Base station 12 can communicate with handsets 14 and handsets 16 using a time division multiplexed (TDM) frame-based communication protocol.

In the implementation of FIG. 2, the system 10 uses an ISM band of radio frequencies for supporting communication between base station 12 and handsets 14 and 16. For example, the system 10 can use the ISM band extending from 2.4 GHz to 2.4835 GHz. An advantage of using the ISM band is that it is unlicensed and does not require a license fee for use. However, in order to operate within FCC or other government regulations, the system 10 implements a frequency hopping scheme. This allows the system 10 to support robust cordless communications in the ISM band while operating within regulation guidelines. Under the frequency hopping scheme, base station 12 and handsets 14 and 16 move in the time domain from frequency to frequency.

Because of the changing frequency, the handsets 14 and 16 are initially in an unlocked state when entering an area serviced by base station 12. Unlocked handsets can then “listen” at a specific radio frequency to attempt to lock on to the base station 12. When the base station 12 hops to that specific frequency, unlocked handsets can identify and receive control data transmitted by the base station 12. This allows unlocked handsets lock with the base station 12 and sync with the frequency hopping scheme.

FIG. 3 is a block diagram of one embodiment of frame frequencies for a frequency hopping cordless telephone system. As shown, a frame structure, indicated generally at 20, comprises a plurality of frames 22 each having a frame length 24. Each frame 22 follows immediately after the previous frame 22 in the time domain. In the embodiment of FIG. 3, a different frequency (F₁, F₂, F₃ . . . F_{N}, F_{N+1}, . . . ) is associated with each frame 22 and is used during that frame 22 for communication across the air interface between base station 12 and handsets 14 and 16. This change from frequency to frequency is handled by the frequency hopping scheme implemented by base station 12 and handsets 14 and 16. During the duration of a given frame 22, base station 12 and handsets 14 and 16 communicate using the selected frequency for that frame 22. When the next frame 22 begins, base station 12 and handsets 14 and 16 communicate using a new selected frequency. An exemplary frequency hopping scheme is described in U.S. patent application Ser. No. 091113,539, filed Jul. 10, 1998, titled “Method and System for Table Implemented Frequency Selection in a Frequency Hopping Cordless Telephone System,” which is hereby incorporated by reference in its entirety as if fully set forth herein.

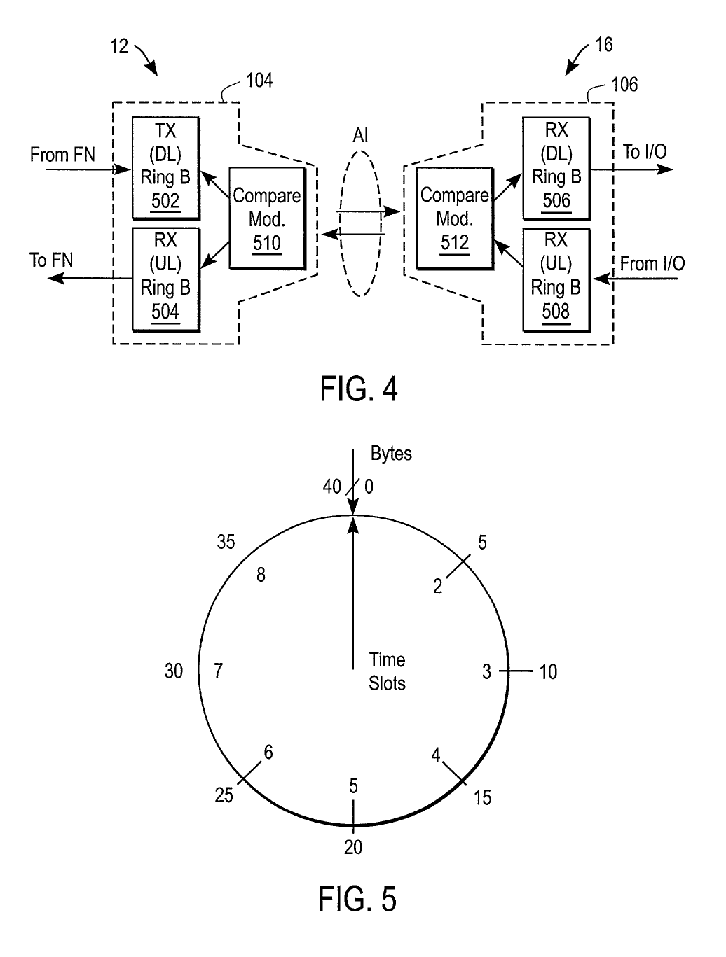

Further, as will be explained in greater detail below, the control logic 104, 106 is operable to identify whether a carrier frequency has been interfered with and to re-transmit, e.g., in a next frame, the lost slot. FIG. 4 is a block diagram of the respective control logic 104, 106 for one connection for implementing such a scheme. Each connection has its own set of ring buffers as described below.

The control logic 104 of the base station 12 includes a transmit downlink (base-to-mobile) ring buffer 502, and a receive uplink (mobile-to-base) ring buffer 504. Also included is a compare module 510. The compare module 510 determines if the frame was interfered with, by evaluating, for example, signal strength, bit error rate, CRC checksum, or the like. If the frequency was interfered with, then, for example, on the next frame, at the next frequency in the hopping scheme, the lost slots are resent, along with the slots of the current frame. The ring buffers 502, 504 adapt the data rates of the fixed network and the air interface, as will be explained in greater detail below. Similarly, the control logic 106 of the mobile unit 16 includes a receive downlink ring buffer 506, a transmit uplink ring buffer 508, and a compare module 512.

FIG. 5 illustrates operation of a ring buffer, such as the ring buffer 502. Operation of the other ring buffers is generally similar. The outer numbers represent the user data in units of bytes, as received from the fixed network (FN). The outer arrow represents the storage process of data from the fixed network. Data are transmitted from the fixed network at a constant rate of 32 kbps and are written into the buffer for 10 milliseconds, where 10 milliseconds is the frame length for a DECT frame. Thus, 320 bits (40 bytes) are read into the ring buffer during the 10 milliseconds.

The inner arrows represent the number of slots in a 10 millisecond frame. The 320 bits (40 bytes) read into the ring buffer from the network are read out, i.e., sent out from the ring buffer over the air interface during a single slot, i.e., 833 microseconds, of the frame. Actual voice data are transmitted during only 555.5 microseconds, however. (Of the 480 bits of an active slot, only 320 are voice data bits).

Data are read constantly into the ring buffer 502 from the fixed network. After 10 milliseconds, the buffer 502 is full, and the 40 bytes are bursted out in one slot. For example, if the second active slot RX2 were selected for transmission, the conversion into the time slot begins when the outer arrow is at position 4 . The read out starts at position 2 of the inner arrow. The reading out process takes place at 576 kbit/s. so that the reading out process of the last 40 bytes of user data is completed in 556 us. The reading out of 40 bytes is symbolized by a complete rotation of the inner arrow. During a complete rotation of the inner arrow, the outer arrow, which continues to rotate continuously, arrives at approximately position 6. The reading out process then terminates. This reading out process repeats every 10 ms. Further details regarding ring buffer operation are described in co-pending patent application PCT/DE97/01315 (WO98/159436), having an international filing date of Jun. 24, 1997, corresponding to U.S. patent application Ser. No. 09/446,198, which are hereby incorporated by reference in its entirety as if fully set forth herein.

Thus, the next user data are received at the mobile station's ring buffer 506 and read out during the next 10 millisecond period. Once the data have been bursted in one time slot, back at the base station 12, the ring buffer 502 is ready to burst out a second slot, but the ring buffer 502 has only read in another 5 bytes, overwriting the previous five. If the previous slot had been interfered with, the data could be bursted again. More particularly, according to an implementation of the present invention, the compare module 512 determines that the data has been interfered, and requests a resend (e.g., over a control channel). Base station 12 then bursts the data that remains in the ring buffer 502 as well as the new data that are being written in, during a time slot that is currently inactive. While the first five (5) bytes are lost, an improvement in voice quality results because not all forty (40) bytes are lost. The retransmission can occur during the same frame on the same frequency or during a succeeding frame on a different frequency. For example, if data are only being transmitted during the first slot, then the data could be retransmitted during the second or third.

If there is a large time period between an active slot and the retransmitted slot, a significant amount of data can be lost, the worst case being 40 bytes (i.e., no repeat slot). The number of bytes that are lost is calculated as follows: # of lost bytes=abs val (# of active slots−# of repeat slots) * 5 bytes. While some data are lost, in general voice quality is improved because not all data are lost.

It is noted that, while described as discrete units, typically, the control logic 104's and control logic 106's functionality is implemented as one or more integrated circuits, such as application specific integrated circuits (ASICs), microcontrollers, microprocessors, or digital signal processors. Thus, the figures are exemplary only.

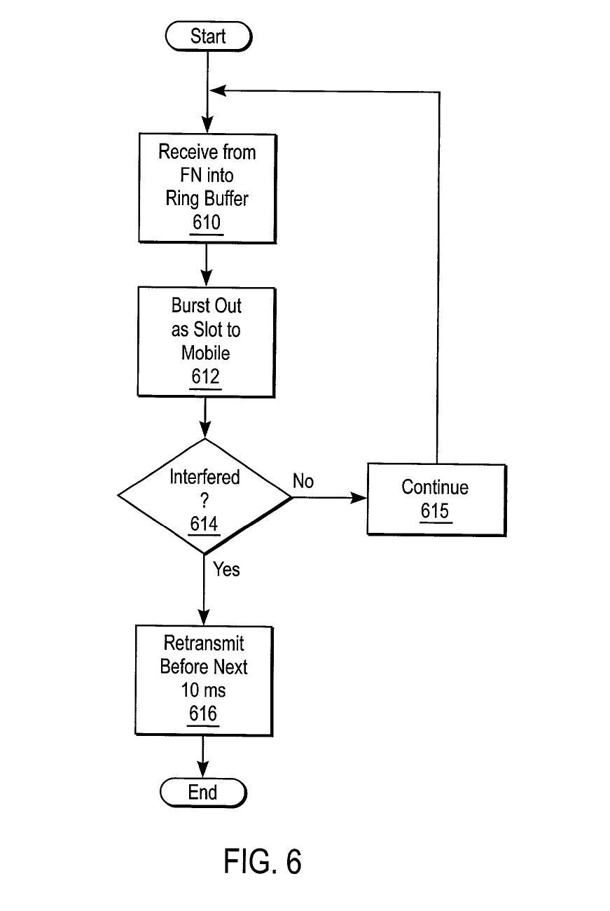

Operation of the present invention is illustrated more clearly with reference to the flowchart of FIG. 6. More particularly, the flowchart of FIG. 6 illustrates handling at the base station 12. Handling at the mobile units is generally similar. In a step 610, the data are read into the ring buffer 502 from the fixed network at a constant rate. Once the ring buffer is full, in a step 612, the data are bursted out as part of a predetermined time slot. Next, in a step 614, the compare module 512 of the mobile station determines if the slot has been interfered with. If not, then in step 614, transmission continues normally. As noted above, the determination may be made according to a variety of methods, such as checksum or signal strength determinations. If interfered with, then a control signal is issued, e.g., over a control channel, telling the base station 12 to retransmit and may include, for example, the identity of the free slot to be used, if such a slot is available. If the data are interfered with, then in step 616, the data are retransmitted during a next available time slot before the ring buffer is overwritten.

The invention described in the above detailed description is not intended to be limited to the specific form set forth herein, but is intended to cover such alternatives, modifications and equivalents as can reasonably be included within the spirit and scope of the appended claims.

What is claimed is:

1. A telecommunications method, comprising:
transmitting a transmit slot as part of a first active connection in a frame at a first frequency between a base station and a mobile unit;
determining that said slot has been interfered with; and
retransmitting at least a predetermined portion of said transmit slot, during a subsequent frame on a second frequency or during the same frame on the same frequency.

2. A telecommunications method in accordance with claim 1, further comprising receiving said transmit slots in a ring memory, wherein data are read into said memory at a first rate and read out of said memory at a second rate higher than said first rate.

3. A telecommunications method in accordance with claim 2, wherein said frame is adapted to include up to four active connections.

4. A telecommunications method in accordance with claim 3, wherein a duration of said frame is ten (10) milliseconds.

5. A telecommunications device, comprising:
a receiver adapted to receive a first data slot in a frame at a first carrier frequency during a communication;
a carrier quality unit adapted to determine if said first carrier frequency is interfered with;
wherein said receiver is adapted to receive a retransmission of said first data slot at a next carrier frequency during a next frame if said first carrier frequency is interfered with or on the same frame during a later slot.

6. A telecommunications device in accordance with claim 5, further comprising a ring memory for storing said first and next data slots, wherein data are read into said ring memory at a first rate and read out of said memory at a second rate higher than said first rate.

7. A telecommunications device, in accordance with claim 6, wherein said receiver is adapted to receive frames of length 10 milliseconds.

8. A telecommunications device in accordance with claim 7, wherein a frame is adapted to include up to four active connections, each connection comprising a transmit slot and a receive slot.

9. A telecommunications device, comprising:
means for transmitting a transmit slot as part of a first active connection in a frame at a first frequency between a base station and a mobile unit;
means for determining that said slot has been interfered with; and
means for retransmitting said transmit slot during a subsequent frame on a second frequency or during the same frame on the same frequency.

10. A telecommunications device in accordance with claim 9, further comprising means for receiving said transmit slots in a ring memory, wherein data are read into said memory at a first rate and read out of said memory at a second rate higher than said first rate.

11. A telecommunications device in accordance with claim 10, wherein said frame is adapted to include up to four active connections.

12. A telecommunications method in accordance with claim 11, wherein a duration of said frame is ten (10) milliseconds.

13. A telecommunications system, comprising:
a plurality of telecommunications devices, at least two of said telecommunications devices comprising:
a receiver adapted to receive a first data slot in a frame at a first carrier frequency during a communication; and
a carrier quality unit adapted to determine if said first carrier frequency is interfered with;
wherein said receiver is adapted to receive a retransmission of said first data slot at a next carrier frequency during a next frame or in the same frame during a later slot if said first carrier frequency is interfered with.

14. A telecommunications system in accordance with claim 13, said at least two further comprising a ring memory for storing said first and next data slots, wherein data are read into said ring memory at a first rate and read out of said memory at a second rate higher than said first rate.
